(19) United States
(12) Patent Application Publication
(10) Pub. No.: US 2026/0001322 A1
(43) Pub. Date: Jan. 1, 2026

(54) METHOD AND APPARATUS FOR CONTROLLING LIQUID EJECTION

(71) Applicant: RISO KAGAKU CORPORATION, Tokyo (JP)

(72) Inventor: Junichi HAKAMADA, Tokyo (JP)

(73) Assignee: RISO KAGAKU CORPORATION, Tokyo (JP)

(21) Appl. No.: 19/248,794

(22) Filed: Jun. 25, 2025

(30) Foreign Application Priority Data
Jun. 28, 2024 (JP) 2024-104649
Jun. 11, 2025 (JP) 2025-097854

(51) Int. Cl. B41J 2/045; B41J 2/21

(52) U.S. Cl. CPC B41J 2/04588; B41J 2/04586; B41J 2/2103

(57) ABSTRACT

A liquid ejection control apparatus includes: a head in which a plurality of ejection heads having nozzles that eject droplets perpendicularly onto a printing surface which is inclined with respect to the horizontal plane, the plurality of ejection heads being arranged in an array direction of the nozzles; a drive voltage correcting unit that applies a drive voltage to each of the ejection heads and corrects the drive voltages for ejection heads which are adjacent to each other in the array direction of the nozzles based on a density difference between the adjacent ejection heads; and a driven nozzle determining unit that determines a nozzle to be driven in each ejection head in an overlap region between the adjacent ejection heads. The determination of the nozzle to be driven by the driven nozzle determining unit is performed after correction of the drive voltage by the drive voltage correcting unit.

### CROSS-REFERENCE TO RELATED APPLICATIONS

The present application claims priority under 35 U.S.C. § 119 to Japanese Patent Application No. 2024-104649, filed on Jun. 28, 2024 and Japanese Patent Application No. 2025-097854, filed on Jun. 11, 2025. The above applications are hereby expressly incorporated by reference, in these entireties, into the present application.

### BACKGROUND OF THE INVENTION

### 1. Field of the Invention

The present disclosure is related to a method and an apparatus for controlling liquid ejection, for controlling ejection of droplets from a head unit having an array of multiple ejection heads.

### 2. Description of the Related Art

Conventionally, ink jet printing apparatuses in which a plurality of ink jet heads are arranged in a direction perpendicular to a conveyance direction of print medium and ejects ink from the plurality of ink jet heads for print processing as the print medium is conveyed have been proposed.

For example, Japanese Unexamined Patent Publication No. 2003-285434 proposes a method for correcting image data to reduce unevenness in density caused by phase differences in ink jet head positions after setting the range of nozzles to be driven in the overlap region of adjacent ink jet heads in an ink jet printing apparatus with a plurality of ink jet heads arrayed as described above.

Meanwhile, not only ink jet printing apparatuses that eject ink from above in the vertical direction onto print medium which are arranged such that printing surfaces thereof are horizontal, but also ink jet printing apparatuses that eject ink from the vertical direction onto printing surfaces which are inclined (for example, vertically) with respect to a horizontal plane have also been proposed.

### SUMMARY OF THE INVENTION

Here, in an ink jet printing apparatus in which the printing surface is vertical and ink is ejected from the ink jet head perpendicularly (horizontally) toward a printing surface, for example, in the case that a plurality of ink jet heads are arranged vertically to form a line head, the landing positions of ink droplets will be shifted downward due to the effect of gravity. The amount of overlap between vertically adjacent ink jet heads can be calculated from a printed image which is influenced by gravity.

However, after determining the amount of overlap among adjacent ink jet heads and determining the range of nozzles to be driven for each ink jet head, if drive voltages are adjusted to compensate for density differences among ink jet heads, heads with increased drive voltages will eject ink droplets at higher flying speeds, resulting in an upward shift in the landing positions thereof. Conversely, in the case that drive voltages are decreased, the flying speed of the ink droplets will be reduced and the landing positions will be shifted downward.

Specifically, as illustrated in FIG. 11A, in the case of correcting the density difference between these ink jet heads 101 and 102 after determining the range of nozzles to be driven in an overlap region of the upper ink jet head 101 and the lower ink jet head 102, for example, if the density of the upper ink jet head 101 is denser than the lower ink jet head 102, a drive voltage of the lower ink jet head 102 is increased to correct the density difference such that it will be reduced.

However, in the case that the drive voltage is corrected in this manner, the ejection speed of ink droplets of the lower ink jet head 102 increases, the effect of gravity on these ink droplets decreases, and the landing positions of the ink droplets shifts upward from that before the drive voltage correction. This results in the elimination of the density difference between the ink jet heads, but as illustrated in FIG. 11B, unevenness in density is caused at a border between the ink jet heads due to the shift of the landing positions of the ink droplets. FIG. 11B illustrates an example FIG. 11B shows an example in which the density at the overlap area increased due to a misalignment in the landing positions. Depending on how the drive voltage is corrected, white streaking may also occur at the border at the overlap area due to the misalignment of the landing positions, and the amount of overlap must be adjusted again, which increases the time and effort required for image adjustment. The present disclosure has been developed in view of the foregoing circumstances. The present disclosure provides a method and an apparatus for controlling liquid ejection which are capable of suppressing unevenness in density at borders among ink jet heads such as that described above.

The liquid ejection control apparatus of the present disclosure is equipped with a head unit in which a plurality of ejection heads having an array of nozzles that eject droplets perpendicularly onto a printing surface which is inclined with respect to the horizontal plane, the plurality of ejection heads being arranged in an array direction of the nozzles, a drive voltage correcting unit that applies a drive voltage to each of the ejection heads and corrects the drive voltages for ejection heads which are adjacent to each other in the array direction of the nozzles based on a density difference between the adjacent ejection heads, and a driven nozzle determining unit that determines a nozzle to be driven in each ejection head in an overlap region between the adjacent ejection heads, the determination of the nozzle to be driven by the driven nozzle determining unit being performed after correction of the drive voltage by the drive voltage correcting unit.

According to the liquid ejection control apparatus of the present disclosure, the nozzles to be driven of adjacent ejection heads are determined after correcting the drive voltages of the adjacent ejection heads. Therefore, unevenness in density at a border between the ejection heads can be suppressed.

### BRIEF DESCRIPTION OF THE DRAWINGS

FIG. 1 is a perspective view that schematically illustrates the exterior of a main body of an ink jet printing apparatus that employs an embodiment of a liquid ejection control apparatus of the present disclosure.

FIG. 2 is a diagram that illustrates an example of six ink jet heads of a line head.

FIG. 3 is a diagram that illustrates the schematic configuration of an ink circulation unit and an ink supply unit.

FIG. 4 is a block diagram that illustrates a control system of the ink jet printing apparatus illustrated in FIG. 1.

FIG. 5A is a diagram that illustrates an example of a solid image printed by adjacent ink jet heads before drive voltage correction.

FIG. 5B is a diagram that illustrates an example of a solid image printed by adjacent ink jet heads after drive voltage correction.

FIG. 6 is a diagram that illustrates an example of the relationship between corrected voltages and changes in density.

FIG. 7A is a diagram that illustrates an example of an overlap region, which is a dot pattern printed by adjacent ink jet heads.

FIG. 7B is a diagram for explaining nozzles to be driven in an overlap region of adjacent ink jet heads.

FIG. 8 is a diagram for explaining the order of an image adjustment process in the ink jet printing apparatus illustrated in FIG. 1.

FIG. 9 is a diagram that illustrates an example of a driven nozzle correction table.

FIG. 10A is a diagram for explaining an example of adjustment of nozzles to be driven based on a corrected voltage.

FIG. 10B is a diagram for explaining another example of adjustment of nozzles to be driven based on a corrected voltage.

FIG. 10C is a diagram for explaining another example of adjustment of nozzles to be driven based on a corrected voltage.

FIG. 11A is a diagram for explaining an example of unevenness in density that occur when density difference correction between ink jet heads is performed after adjusting the driven nozzles.

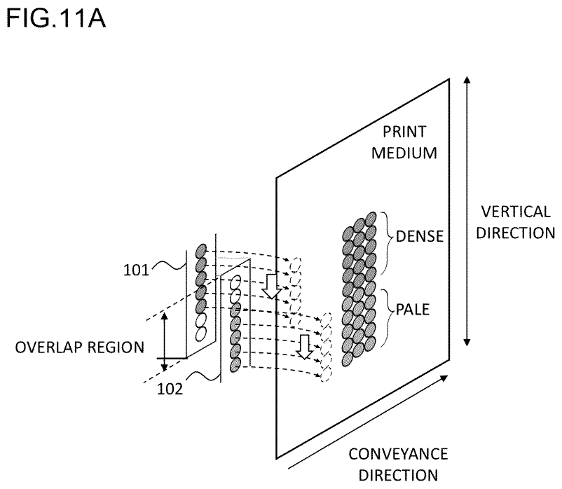

FIG. 11B is a diagram for explaining another example of unevenness in density that occur when density difference correction between ink jet heads is performed after adjusting the driven nozzles.

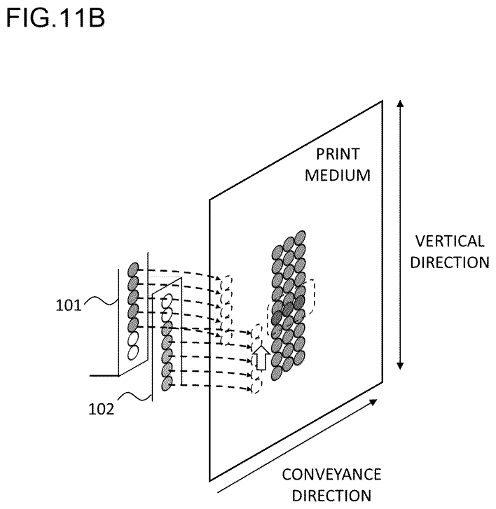

### DETAILED DESCRIPTION OF THE EMBODIMENTS

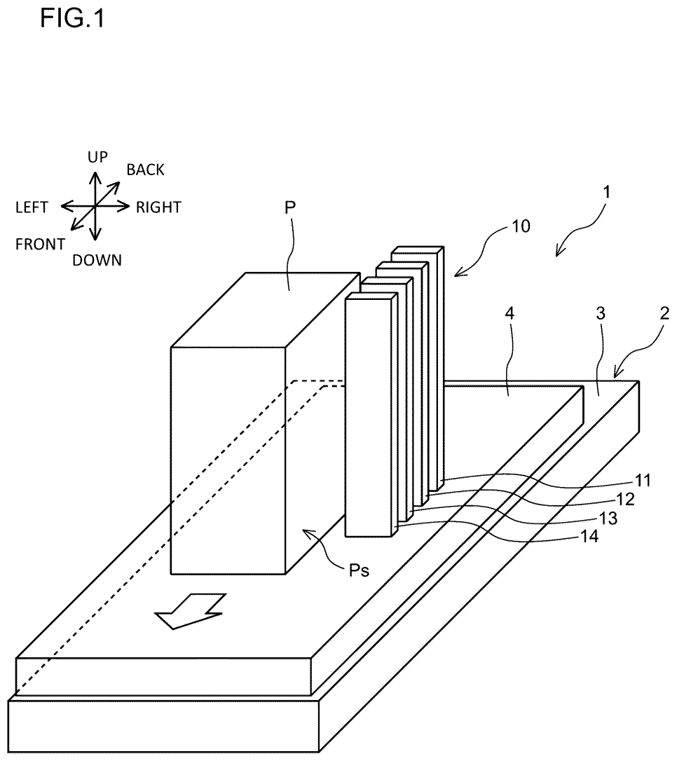

An ink jet printing apparatus that employs an embodiment of a liquid ejection control apparatus of the present disclosure will be described in detail below with reference to the attached drawings. The ink jet printing apparatus of the present embodiment is characterized by a method of adjusting a drive voltage and driven nozzles of an ink jet head. First, the overall configuration of the ink jet printing apparatus will be described. FIG. 1 is a perspective view that schematically illustrates the exterior of a main body 1 of the ink jet printing apparatus. In the following description of the present embodiment, the up, down, left, right, front, and back directions indicated by the arrows in FIG. 1 are designated as the vertical, horizontal, left, right, front, and back directions of the main body 1 of the ink jet printing apparatus 1.

As illustrated in FIG. 1, the main body 1 of the ink jet printing apparatus is equipped with a head unit 10 and a conveyance unit 2.

The conveyance unit 2 conveys a print medium P in the direction of the arrow illustrated in FIG. 1. A three dimensional object (e.g., a box shaped article such as a corrugated cardboard box) having a printing surface Ps that stands perpendicular to a conveyance surface such as that illustrated in FIG. 1 may be employed as the print medium P. In the present embodiment, the conveyance surface is parallel to the horizontal plane.

The conveyance unit 2 has a support stand 3 and a conveyor belt unit 4. The support stand 3 is a stand that supports the conveyor belt unit 4.

The conveyor belt unit 4 is equipped with a plurality of rollers that extend in a direction perpendicular to a conveyance direction of the print medium P, a conveyor belt, etc. The plurality of rollers are arranged in parallel, spaced apart with respect to the conveyance direction of the print medium P. An annular conveyor belt is suspended between the plurality of rollers which are arranged in parallel, and the rollers rotate to move the conveyor belt, thereby conveying the print medium P.

The head unit 10 administers printing by ejecting ink perpendicularly onto the printing surface Ps of the print medium P which is conveyed by the conveyance unit 2.

The head unit 10 has four line heads 11, 12, 13, and 14, as illustrated in FIG. 1. The four line heads 11 through 14 extend vertically and are arranged in parallel with respect to the conveyance direction of the print medium P. In the present embodiment, each of the line heads 11 through 14 corresponds to a head unit of the present disclosure.

The four line heads 11 through 14 eject K (black), C (cyan), M (magenta), and Y (yellow) ink, respectively.

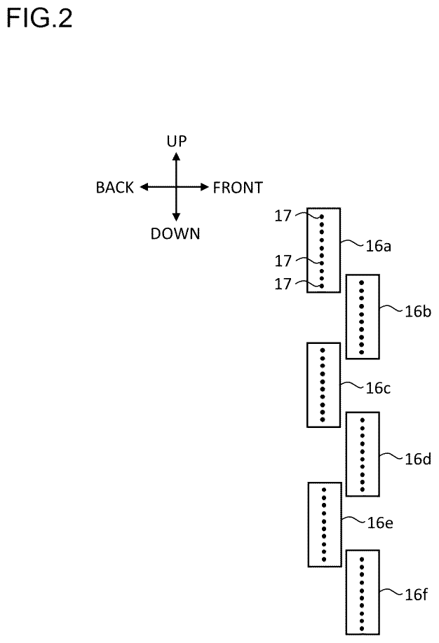

Each of the line heads 11 through 14 of the present embodiment has six ink jet heads 16a through 16f, as illustrated in FIG. 2. The six ink jet heads 16a through 16f are arranged such that the ink ejection directions thereof are perpendicular to the printing surface Ps. That is, in the present embodiment, they are arranged such that the ink ejection direction of the ink jet heads 16a through 16f is horizontal. Any of the six ink jet heads 16a through 16f may hereinafter be referred to simply as an ink jet head 16.

The ink jet heads 16a through 16f each have a plurality of nozzles 17 which are arranged in a predetermined direction. The nozzles 17 respectively eject ink supplied to the ink jet heads 16a through 16f toward the printing surface Ps.

The six ink jet heads 16a through 16f are arranged such that the arrangement direction of the nozzles 17 is the vertical direction, and further arranged in a staggered arrangement with respect to the conveyance direction, as illustrated in FIG. 2. In the present embodiment, some of the nozzles 17 of vertically adjacent ink jet heads are arranged such that they overlap in the vertical direction. The vertically adjacent ink jet heads are ink jet heads which are immediately adjacent to each other in the vertical direction. In the present embodiment, ink jet head 16a and ink jet head 16b, ink jet head 16b and ink jet head 16c, ink jet head 16c and ink jet head 16d, ink jet head 16d and ink jet head 16e, and ink jet head 16e and ink jet head 16f are vertically adjacent ink jet heads. In the present embodiment, areas that overlap between adjacent ink jet heads 16 in the vertical region are referred to as overlap regions.

Straight lines that extend in the vertical direction are printed by ejecting ink at preset timings from the six ink jet heads 16a through 16f which are arranged in the manner described above.

The ink jet printing apparatus is also equipped with an ink circulation unit 20 connected to each of the line heads 11 through 14 and an ink supply unit 40 connected to the ink circulation unit 20.

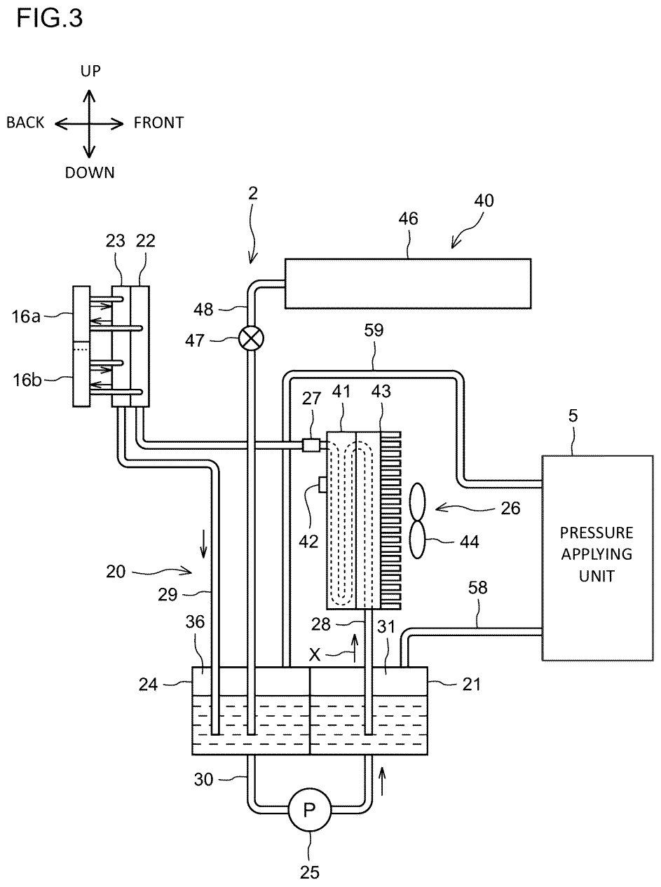

FIG. 3 illustrates the ink circulation unit 20 connected to two ink head jets 16a and 16b from among the six ink jet heads 16a through 16f of the line head 11, and the ink supply unit 40 which is connected to the ink circulation unit 20. Note that FIG. 3 only illustrates the two ink jet heads 16a and 16b are shown. However, in the present embodiment, the ink circulation unit 20 and the ink supply unit 40 are provided for each pair of two ink jet heads 16. That is, the ink circulation unit 20 and the ink supply unit 40 are provided for a pair of two ink jet heads 16c and 16d, and a pair of two ink jet heads 16e and 16f, respectively. Similarly, for the line heads 12 through 14 other than the line head 11, the ink circulation unit 20 and the ink supply unit 40 are provided for each pair of two ink jet heads 16.

The ink circulation unit 20 supplies ink to the ink jet heads 16a and 16b while circulating ink. The ink circulation unit 20 is equipped with a pressurized tank 21, a distributor 22, a collector 23, a negative pressure tank 24, an ink pump 25, an ink temperature adjusting unit 26, an ink temperature sensor 27, and ink circulation pipes 28 through 30.

The pressurized tank 21 stores ink to be supplied to the ink jet heads 16a and 16b. Ink in the pressurized tank 21 is supplied to the ink jet heads 16a and 16b through the ink circulation pipe 28 and the distributor 22. In the pressurized tank 21, an air layer 31 is formed above the liquid surface of the ink. The air layer 31 of the pressurized tank 21 is connected to a pressurizing unit 5 to be described below via a pressure communicating pipe 58 described below. The pressurized tank 21 is located at a position lower than (below) the line heads 11 through 14.

The distributor 22 distributes ink supplied from pressurized tank 21 via the ink circulation pipe 28 to the ink jet heads 16a and 16b.

The collector 23 collects ink that has not been consumed by the ink jet heads 16a and 16b from the ink jet heads 16a and 16b. The ink collected by the collector 23 flows into the negative pressure tank 24 via the ink circulation pipe 29.

The negative pressure tank 24 receives and stores ink that has not been consumed by the ink jet heads 16a and 16b from the collector 23 via the ink circulation pipe 29. The negative pressure tank 24 also stores ink supplied from an ink cartridge 46 within the ink supply unit 40 to be described below. In the negative pressure tank 24, an air layer 36 is formed above the liquid surface of the ink. The air layer 36 of the negative pressure tank 24 is connected to the pressurizing unit 5 via a negative pressure connection pipe 59 to be described below. The negative pressure tank 24 is located at the same height as the pressure tank 21.

The ink pump 25 pumps ink from the negative pressure tank 24 to the pressurized tank 21. The ink pump 25 is installed at an intermediate position of the ink circulation pipe 30.

The ink temperature adjusting unit 26 adjusts the temperature of the ink in the ink circulation unit 20. The ink temperature adjusting unit 26 is provided at an intermediate position of the ink circulation pipe 28. The ink temperature adjusting unit 26 is equipped with a heater 41, a heater temperature sensor 42, a heat sink 43, and a cooling fan 44.

The heater 41 heats the ink in the ink circulation pipe 28. The heater temperature sensor 42 detects the temperature of the heater 41. The heat sink 43 cools the ink within the ink circulation pipe 28 by heat dissipation. The cooling fan 44 sends cooling air to the heat sink 43.

The ink temperature sensor 27 detects the temperature of the ink in the ink circulation unit 20. The ink temperature sensor 27 is installed at an intermediate position of the ink circulation pipe 28. The ink temperature sensor 27 may be constituted by a power thermistor, for example.

The ink circulation pipe 28 connects the pressurized tank 21 to the distributor 22. The ink circulation pipe 28 passes through the heater 41 after passing through the heat sink 43. Ink flows in the ink circulation pipe 28 from the pressurized tank 21 to the distributor 22. Ink circulation pipe 29 connects the collector 23 to the negative pressure tank 24. Ink flows in the ink circulation pipe 29 from the collector 23 toward the negative pressure tank 24.

The ink circulation pipe 30 connects the negative pressure tank 24 to the pressurized tank 21. Ink flows in the ink circulation pipe 30 from the negative pressure tank 24 to the pressurized tank 21. The ink circulation pipes 28 through 30, the distributor 22, and the collector 23 constitute a circulation path for circulating ink among the pressurized tank 21, the line head 11, and the negative pressure tank 24.

The ink supply unit 40 supplies ink from the ink cartridge 46 to the negative pressure tank 24 of the ink circulation unit 20 via an ink supply pipe 48 while an ink supply valve 47 is open.

The pressurizing unit 5 applies pressure to the air layer 31 of the pressurized tank 21 and the air layer 36 of the negative pressure tank 24 to circulate ink. The pressurizing unit 5 can individually seal and connect the air layer 31 of the pressurized tank 21 and the air layer 36 of the negative pressure tank 24 from and to the atmosphere. The pressurizing unit 5 can then apply positive pressure to the air layer 31 of the pressurized tank 21 via the pressure communicating pipe 58. The pressurizing unit 5 can also apply negative pressure to the air layer 36 of the negative pressure tank 24 via a negative pressure communicating pipe 59.

Then, a meniscus is formed at the outlet of each nozzle of the ink jet heads 16a and 16b by the adjustment of positive pressure and negative pressure by the pressurizing unit 5.

In order to maintain the nozzle pressure applied to each of the ink jet heads 16a and 16b within a range for stable ejection, the average nozzle pressure of the ink jet head 16a and the average nozzle pressure of the ink jet head 16b are equalized by adjustment of positive pressure and negative pressure by the pressurizing unit 5 and by adjusting the diameter of the ink path leading to each ink jet head 16a and 16b to provide a difference in flow path resistance.

However, even if the average nozzle pressure of the ink jet head 16a and the average nozzle pressure of the ink jet head 16b are equalized in this manner, a pressure difference between the nozzle at the lower end of the vertically higher ink jet head 16a and the nozzle at the upper end of the vertically lower ink jet head 16b will remain. Particularly, in the case that the average nozzle pressure of the ink jet head 16a and that of the ink jet head 16b are equalized as described above, the above pressure difference becomes larger than before the equalization. Although the adjustment of nozzle pressure for the ink jet head 16a and 16b pairs is described here, the same applies to the pair of the ink jet heads 16c and 16d, and the pair of ink jet heads 16e and 16f.

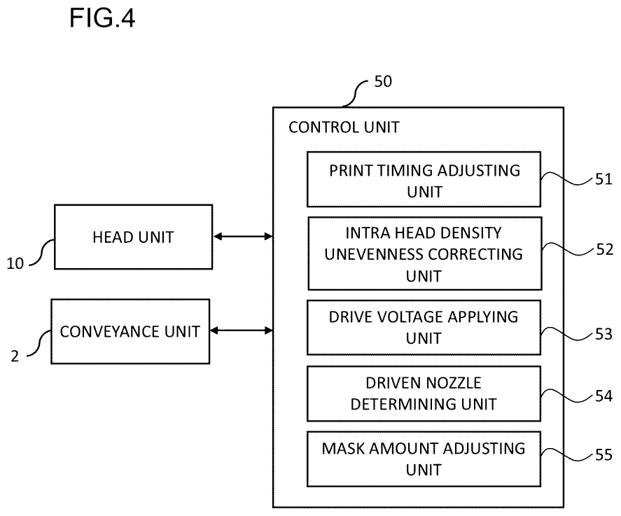

FIG. 4 is a block diagram that illustrates a control system of the ink jet printing apparatus. A control unit 50 is equipped with a CPU (Central Processing Unit) and a storage medium such as semiconductor memory or a hard disk, and controls the entirety of the ink jet printing apparatus. The control unit 50 controls the operation of each component of the ink jet printing apparatus by executing a control program which is stored in advance in a storage medium such as semiconductor memory or a hard disk, and by operating electrical circuits.

Particularly, the control unit 50 controls the ink jet heads 16a through 16f of each of the line heads 11 to 14 based on image data to be printed.

Specifically, the control unit 50 has a print timing adjusting unit 51, an intra head density unevenness correcting unit 52, a drive voltage applying unit 53, a driven nozzle determining unit 54, and a mask amount adjusting unit 55.

The print timing adjusting unit 51 adjusts the timing of printing by each of the ink jet heads 16a through 16f of each of the line heads 11 through 14 with respect to the conveyance direction of the print medium P. The print timing adjustment is performed based on read out data which is obtained by printing a preset print timing adjustment pattern by the main body 1 of the ink jet printing apparatus and reading out the result of printing, for example. Conventional methods may be used as the specific adjustment method.

The intra head density unevenness correcting unit 52 corrects unevenness in density within each of the ink jet heads 16a through 16f. Unevenness in density is corrected based on read out data which is obtained by printing a pattern for unevenness in density correction, such as a solid image with uniform density, by the main body 1 of the ink jet printing apparatus and then reading out the result of printing, for example. Specifically, unevenness in density due to differences in the printing density of each nozzle is detected from the result of printing by one ink jet head 16, and the amount of ink ejected by each nozzle is adjusted based on the unevenness in density. Conventional methods may be used as the specific method of adjusting the amount of ink ejected by each nozzle.

The drive voltage applying unit 53 applies a drive voltage to each of the ink jet heads 16a through 16f of each of the line heads 11 through 14. Each of the ink jet heads 16a through 16f ejects ink based on the applied drive voltage and ink dot data which is set for each nozzle 17. The ink dot data is data generated from the image data to be printed and specifies the number of droplets of ink to be ejected from each nozzle.

The drive voltage applying unit 53 corresponds to the drive voltage correcting unit of the present disclosure, and corrects the drive voltage applied to each of the ink jet heads 16a through 16f, respectively. Specifically, the drive voltage applying unit 53 corrects the drive voltage such that a difference in density between the ink jet heads 16 which are adjacent to each other in the vertical direction is reduced.

The correction of drive voltages of adjacent ink jet heads 16 is performed based on read out data obtained by printing a pattern for density difference correction, such as a solid color image with uniform density, by the ink jet printing apparatus 1 and reading out the result of printing, for example. The read out data is read by a scanner unit, which is not illustrated in the drawing.

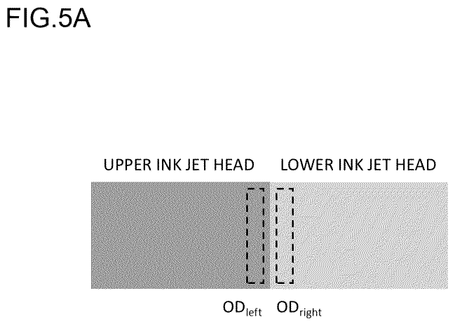

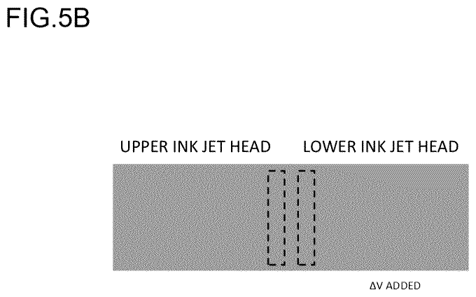

Specifically, the drive voltage applying unit 53 calculates the respective average density of adjacent ink jet heads 16 from the read out data of the pattern for density difference correction printed by the adjacent ink jet heads 16. FIG. 5A illustrates an example of a solid image printed by adjacent ink jet heads 16 before the drive voltage is corrected. The pattern on the left is the solid image printed by the upper ink jet head 16, and the pattern on the right is the solid image printed by the lower ink jet head 16.

The drive voltage applying unit 53 calculates the average density of areas in the vicinity of a border between the left side pattern and the right side pattern, that is, the areas indicated by the dotted squares, respectively. At the time that the drive voltages of adjacent ink jet heads 16 are corrected, the nozzles to be driven in the overlap region of adjacent ink jet heads 16 have not yet been adjusted, so there may be a partial overlap or a gap between the left side pattern and the right side pattern. Therefore, the ranges for calculating the average density are set as close as possible to the borders while avoiding such partially overlapping areas and gaps.

The drive voltage applying unit 53 then calculates ΔOD, which is the difference between an average density OD_{left} within the range of the dotted square in the left side pattern and an average density OD_{right} within the range of the dotted square in the right side pattern (ΔOD=OD_{left}−OD_{right}). The drive voltage applying unit 53 calculates a correction voltage ΔV by calculating the following formula based on this difference in density ΔOD.

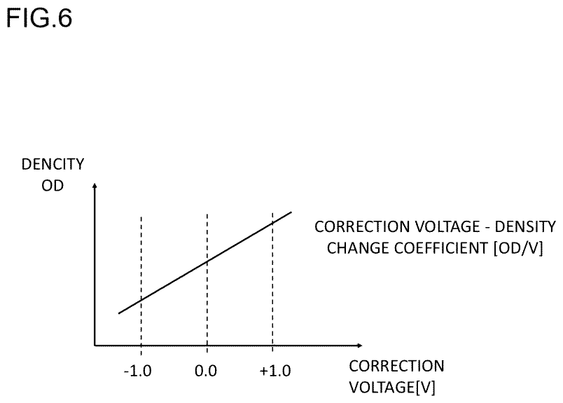

ΔV=ΔOD/coeff
coeff is a correction voltage-density change coefficient [OD/V], which is a preset value. Specifically, the drive voltage of the ink jet head 16 is varied within a certain range, and density changes in response to changes in drive voltage are obtained in advance. FIG. 6 illustrates an example of the relationship between correction voltages and density changes. The correction voltage-density change coefficient coeff is calculated by calculating the slope of the function illustrated in FIG. 6.

The drive voltage applying unit 53 corrects the drive voltage by adding the correction voltage ΔV calculated as described above to the drive voltage of the ink jet head 16 with the lower density. FIG. 5B illustrates an example of a solid image printed by adjacent ink jet head 16 after the drive voltage has been corrected. Note that in the present embodiment, with respect to the correction of the density difference between the ink jet heads 16, the drive voltage of the lower ink jet head 16 is corrected with the density of the upper ink jet head 16 of the two adjacent ink jet heads 16 as a standard.

The driven nozzle determining unit 54 determines nozzles to be driven of each ink jet head 16 in the overlap region between adjacent ink jet heads 16. Determination of the nozzles to be driven is performed based on read out data, which is obtained by printing a pattern for determining nozzles to be driven to obtain the relative positional relationship of adjacent ink jet heads 16 by the main body 1 of the ink jet printing apparatus and reading out the result of printing, for example.

The driven nozzle determining unit 54 then employs the read out data to obtain the relative positional relationship of adjacent ink jet heads 16 and measures the overlap region of adjacent ink jet heads 16 based on that positional relationship.

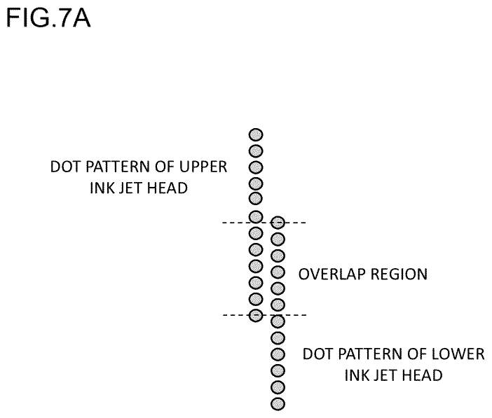

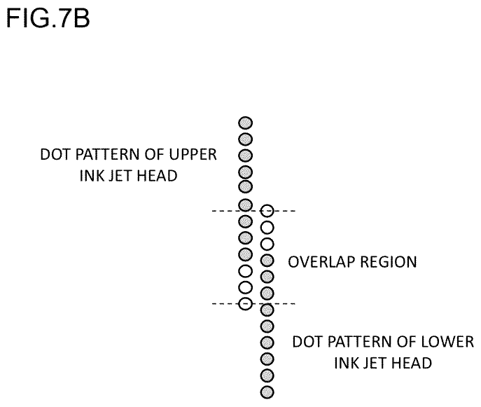

FIG. 7A illustrates an example of an overlap region, which is a dot pattern printed by adjacent ink jet heads 16. The range indicated by the dotted arrows in FIG. 7A is the overlap region. The method for determining the overlap region is not limited to the method described above. For example, a dot pattern as illustrated in FIG. 7A may be printed, or other conventional methods may be employed.

Then, the driven nozzle determining unit 54 determines the nozzles, excluding those from the outermost nozzle on the overlap region side of each inkjet head 16 to the nozzle corresponding to half of the overlap region, are designated as the drive nozzles, for example. In FIG. 7B, the white circles indicate unused nozzles, and the gray circles indicate driven nozzles.

The mask amount adjusting unit 55 obtains position information of the edges of the print medium P and adjusts a mask amount of the image data to be printed based on the position information. That is, the mask amount adjusting unit 55 masks the image data such that ink is not ejected beyond the edges of the print medium P. The position information of the edges of the print medium P is detected, for example, by a sensor which is not illustrated in the drawing.

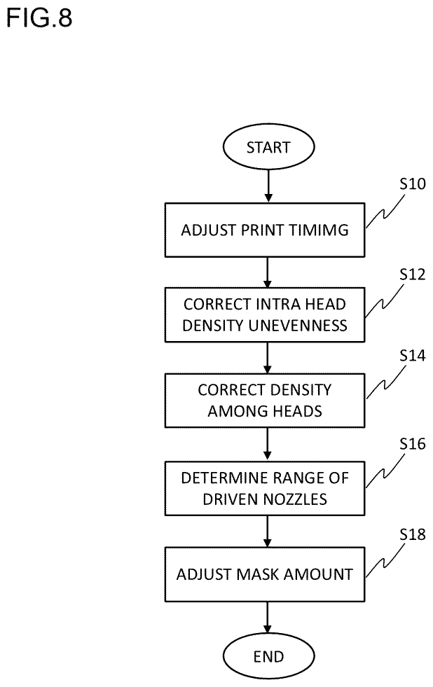

Next, the order of the image adjustment process in this ink jet printing apparatus will be described with reference to the flowchart illustrated in FIG. 8.

First, the print timing adjustment process is performed by the print timing adjusting unit 51 (S10). Specifically, the timings of printing by each of the ink jet heads 16a through 16f of each of the line heads 11 through 14 are adjusted.

Next, intra head density unevenness is corrected by the intra head density unevenness correcting unit 52 (S12). Specifically, unevenness in density within each ink jet head 16a through 16f is corrected.

Next, density adjustment among heads is performed by the drive voltage applying unit 53 (S14). Specifically, drive voltages are corrected to reduce density differences between adjacent ink jet heads 16.

After the density adjustment among heads is performed, the process of determining the range of nozzles to be driven by the driven nozzle determining unit 54 is performed (S16). Specifically, the nozzles to be driven in each ink jet head 16 within the overlap regions of adjacent ink jet heads 16 are determined.

Finally, the mask amount of the image data to be printed is adjusted by the mask amount adjusting unit 55 (S18).

Then, after the image adjustment process described above is performed, the printing process based on the image data to be printed is performed. Specifically, ink is sequentially ejected in the horizontal direction from each of the line heads 11 through 14 as the print medium P is conveyed by the conveyance unit 2, and the printing process is administered thereby.

According to the ink jet printing apparatus of the above embodiment, the nozzles to be driven in adjacent ink jet heads 16 are determined after the drive voltages of the adjacent ejection heads 16 are corrected. Therefore, unevenness in density at the borders between the ejection heads can be suppressed.

Here, after performing the image adjustment process as described above, if there is a change in the state of the ink jet printer, such as a change in the installation position of the main body 1 of the ink jet printing apparatus, there are cases in which the positions of the ink jet heads 16 are adjusted. In such cases, density adjustment among heads is performed again, but this density adjustment among heads changes the ejection speed of ink droplets from each of the ink jet heads 16, resulting in a misalignment of the landing positions, which again requires the process of determining the nozzles to be driven.

In this case, the process of determining the nozzles to be driven is extremely burdensome if the driven nozzle determination pattern is printed and adjusted as described above. In addition, it is a very time consuming and difficult process for maintenance personnel to perform at the site where the main body 1 of the ink jet printing apparatus is installed, for example.

Therefore, the range of nozzles to be driven may be corrected based on the correction voltage ΔV which was determined in the density adjustment among heads to determine the nozzles to be driven, for example. Specifically, the amount of misalignment of the landing positions in response to changes in the drive voltage of the ink jet head 16 is measured, and a table in which the correction voltage ΔV is correlated to the correction amount of the range of nozzles to be driven is created and set up in advance based on the measurement results.

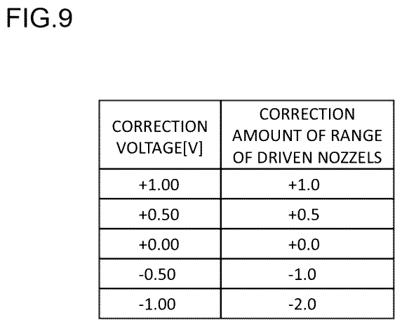

FIG. 9 illustrates an example of a driven nozzle correction table in which the correction voltage ΔV is correlated to the correction amount of the range of nozzles to be driven. In the case that the correction amount of the range of nozzles to be driven in the table illustrated in FIG. 9 is “+”, it means that the range of nozzles to be driven is to be corrected vertically upward, and in the case that the correction amount is “−”, it means that the range of nozzles to be driven is to be corrected vertically downward. In the case that the correction amount of the range of nozzles to be driven is a decimal point, it means that the amount of ink (number of drops) of the nozzle at the edge is adjusted instead of adjusting the range of nozzles to be driven. For example, “+0.5” means that the amount of ink is reduced to 50%.

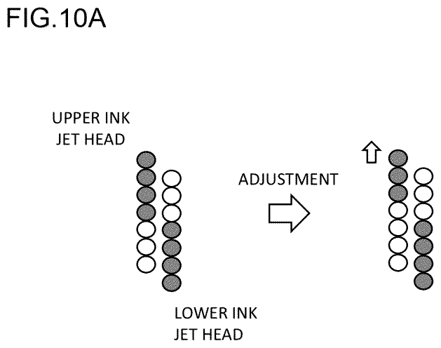

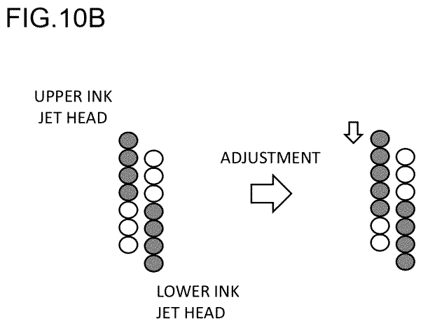

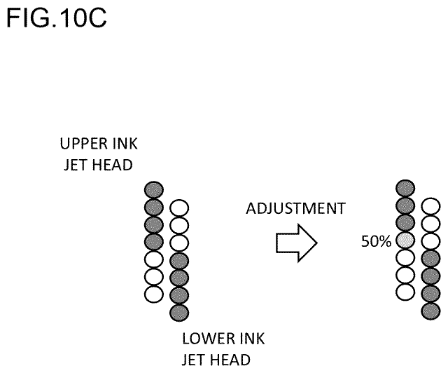

The driven nozzle determining unit 54 determines the nozzles to be driven based on the driven nozzle correction table illustrated in FIG. 9. For example, if the correction voltage ΔV of a lower ink jet head 16 of adjacent ink jet heads 16 is +1.0V, the landing position is shifted upward by one nozzle. Therefore, the driven nozzle range of the upper ink jet head 16 is shifted upward by one nozzle, as illustrated in FIG. 10A. If the correction voltage ΔV of the lower ink jet head 16 is-0.5 V, the landing position is shifted downward by one nozzle. Therefore, the driven nozzle range of the upper ink jet head 16 is shifted downward by one nozzle, as illustrated in FIG. 10B. If the correction voltage ΔV of the lower ink jet head 16 is +0.5 V, the landing position is shifted upward by 0.5 nozzle. Therefore, the amount of ink in the boundary nozzles of the upper ink jet head 16 is set to 50%, as illustrated in FIG. 10C.

In the case that the driven nozzles of adjacent ink jet heads 16 are determined based on the correction amount of drive voltage as described above, the process of adjusting the driven nozzles can be simplified and expedited.

In addition, in the case that the driven nozzles of each ink jet head 16 are determined using the driven nozzle correction table as described above, the driven nozzles can be determined by a simpler process.

Note that in the description above, when there is a change in the state of the ink jet printing apparatus 1 and density adjustment among heads is performed again, the correction amount of the correction voltage and the driven nozzle correction table are employed in the process of determining the driven nozzles. However, this is not limited to cases where there is a change in the state of the main body 1 of the ink jet printing apparatus. During the first process for determining the driven nozzles at S16 in the flow chart of FIG. 8, the process for determining driven nozzles may be performed by employing the correction amount of the correction voltage and the driven nozzle correction table.

In addition, the change in ink ejection speed when the drive voltage of the ink jet head 16 is corrected differs depending on the type of ink and the individual ink jet head 16. Accordingly, a driven nozzle correction table such as that illustrated in FIG. 8 may be set for each ink type and each ink jet head 16.

Further, a misalignment of the landing positions when the drive voltage of the ink jet head 16 is corrected differs depending on head gap, which is the distance between the ink jet head 16 and the print medium P. Therefore, a driven nozzle correction table may be set for each head gap, and the driven nozzle determination process may be performed using the driven nozzle correction table corresponding to the head gap at the time of actual printing. If the head gap at the time of actual printing is not in the driven nozzle correction table, the correction amount corresponding to the head gap closest to the head gap at the time of actual printing may be employed to interpolate the head gap at the time of actual printing.

Still further, the misalignment of the landing position when the drive voltage of the ink jet head 16 is corrected also differs depending on the number of ink droplets which are ejected from the ink jet head 16. Specifically, the greater the number of ejected ink droplets, the faster the ink droplets are ejected, and the fewer the number of ejected ink droplets, the slower the ink droplets are ejected, resulting in different landing position deviation.

Accordingly, the driven nozzle correction table may be set for each number of droplets. Then, the number of droplets at the time of printing of the nozzles at the boundary portion of the lower ink jet head 16 of the adjacent ink jet heads 16 may be obtained, and the process of determining the driven nozzles may be performed by employing the driven nozzle correction table corresponding to the number of droplets. If the number of droplets of the nozzles in the boundary portion at the time of actual printing is not in the driven nozzle correction table, a correction amount corresponding to the number of droplets closest to the number of droplets at the time of actual printing may be used to interpolate the number of droplets at the time of actual printing.

In addition, the driven nozzle correction table may be set according to the head gap and the number of droplets, respectively, and the driven nozzle determination process may be performed using the driven nozzle correction table according to the head gap and the number of droplets during actual printing.

Further, the misalignment of the landing positions when the drive voltage of the ink jet head 16 is corrected also differs depending on the head drive frequency of the ink jet head 16. Specifically, the higher the head drive frequency, the faster the ejection speed of ink droplets becomes, and the lower the head drive frequency, the slower the ejection speed of ink droplets becomes. As a result, the misalignment in the landing position differs.

Accordingly, the driven nozzle correction table may be set for each head drive frequency. Then, the head drive frequency at the time of printing may be obtained, and the process of determining the driven nozzle may be performed using the drive nozzle correction table corresponding to that head drive frequency. If the head drive frequency at the time of actual printing is not in the driven nozzle correction table, the correction amount corresponding to the head drive frequency closest to the head drive frequency at the time of actual printing may be used to interpolate the head drive frequency at the time of actual printing.

The driven nozzle correction table may be set according to the head gap and head drive frequency, respectively, and the driven nozzle determination process may be performed using the driven nozzle correction table according to the head gap and head drive frequency during actual printing.

The number of ink droplets and head drive frequency are both parameters related to the amount of ink ejected.

The present disclosure is not limited to the embodiment described above, but may be embodied by modifying each of the components to an extent that it does not depart from the spirit thereof at a stage of implementation. Also, various configurations may be achieved by appropriate combinations of the plurality of components disclosed in the above embodiment. For example, all of the components disclosed in the embodiment may be combined as appropriate. It is a matter of course that various modifications and applications are possible within a scope that does not depart from the spirit of the present disclosure.

The following items are further disclosed with respect to the present disclosure.

### (Item 1)

The liquid ejection control apparatus of the present disclosure is equipped with a head unit in which a plurality of ejection heads having an array of nozzles that eject droplets perpendicularly onto a printing surface which is inclined with respect to the horizontal plane, the plurality of ejection heads being arranged in an array direction of the nozzles, a drive voltage correcting unit that applies a drive voltage to each of the ejection heads and corrects the drive voltages for ejection heads which are adjacent to each other in the array direction of the nozzles based on a density difference between the adjacent ejection heads, and a driven nozzle determining unit that determines a nozzle to be driven in each ejection head in an overlap region between the adjacent ejection heads, the determination of the nozzle to be driven by the driven nozzle determining unit being performed after correction of the drive voltage by the drive voltage correcting unit.

### (Item 2)

In the liquid ejection control apparatus according to Item 1, the driven nozzle determining unit may determine the nozzle to be driven for each ejection head based on a correction amount of the drive voltage by the drive voltage correcting unit.

### (Item 3)

In the liquid ejection control apparatus according to Item 1, if the drive voltage is corrected again by the drive voltage correcting unit after the nozzle to be driven is determined, the driven nozzle determining unit may determine the nozzle to be driven for each ejection head based on the correction amount of the drive voltage by the drive voltage correcting unit.

### (Item 4)

In the liquid ejection control apparatus according to Item 2 or 3, the driven nozzle determining unit may determine the nozzle to be driven for each ejection head using a table in which the correction amount of the drive voltage is correlated to the correction amount of a range of nozzles to be driven.

### (Item 5)

In the liquid ejection control apparatus according to Item 4, the driven nozzle determining unit may have the table for each distance between the head unit and the printing surface, and may determine the nozzles to be driven for each ejection head according to the distance between the head unit and the printing surface during printing.

### (Item 6)

In the liquid ejection control apparatus according to Item 4 or 5, the driven nozzle determining unit may have the table for each amount of ink ejected from the ejection head and may determine the nozzles to be driven for each ejection head according to the amount of ink ejected during printing.

### (Item 7)

A liquid ejection control method of the present disclosure controls liquid ejection by applying a drive voltage to each ejection head of a head unit in which a plurality of the ejection heads having an array of nozzles that eject droplets perpendicularly onto a printing surface which is inclined with respect to the horizontal plane, the plurality of ejection heads being arranged in an array direction of the nozzles, nozzles to be driven of each ejection head in an overlap region between adjacent ejection heads are determined after correcting the drive voltages of adjacent ejection heads based on the density difference between adjacent ejection heads.

What is claimed is:

1. A liquid ejection control apparatus, comprising:
a head unit in which a plurality of ejection heads having an array of nozzles that eject droplets perpendicularly onto a printing surface which is inclined with respect to the horizontal plane, the plurality of ejection heads being arranged in an array direction of the nozzles;
a drive voltage correcting unit that applies a drive voltage to each of the ejection heads and corrects the drive voltages for ejection heads which are adjacent to each other in the array direction of the nozzles based on a density difference between the adjacent ejection heads; and
a driven nozzle determining unit that determines a nozzle to be driven in each ejection head in an overlap region between the adjacent ejection heads;
the determination of the nozzle to be driven by the driven nozzle determining unit being performed after correction of the drive voltage by the drive voltage correcting unit.

2. The liquid ejection control apparatus according to claim 1, wherein:
the driven nozzle determining unit determines the driven nozzle of each ejection head based on a correction amount of the drive voltage by the drive voltage correcting unit.

3. The liquid ejection control apparatus according to claim 1, wherein:
if the drive voltage is corrected again by the drive voltage correcting unit after the nozzle to be driven is determined, the driven nozzle determining unit determines the nozzle to be driven for each ejection head based on the correction amount of the drive voltage by the drive voltage correcting unit.

4. The liquid ejection control apparatus according to claim 2, wherein:
the driven nozzle determining unit determines the nozzle to be driven for each ejection head using a table in which the correction amount of the drive voltage is correlated to the correction amount of a range of nozzles to be driven.

5. The liquid ejection control apparatus according to claim 4, wherein:
the driven nozzle determining unit has the table for each distance between the head unit and the printing surface, and
determines the nozzles to be driven for each ejection head according to the distance between the head unit and the printing surface during printing.

6. The liquid ejection controller according to claim 4, wherein:
the driven nozzle determining unit has the table for each amount of ink ejected from the ejection head; and
determines the nozzles to be driven for each ejection head according to the amount of ink ejected during printing.

7. The liquid ejection control apparatus according to claim 3, wherein:
the driven nozzle determining unit determines the nozzle to be driven for each ejection head using a table in which the correction amount of the drive voltage is correlated to the correction amount of a range of nozzles to be driven.

8. The liquid ejection control apparatus according to claim 7, wherein:
the driven nozzle determining unit has the table for each distance between the head unit and the printing surface, and
determines the nozzles to be driven for each ejection head according to the distance between the head unit and the printing surface during printing.

9. The liquid ejection controller according to claim 7, wherein:
the driven nozzle determining unit has the table for each amount of ink ejected from the ejection head; and
determines the nozzles to be driven for each ejection head according to the amount of ink ejected during printing.

10. A liquid ejection control method, comprising:
controlling liquid ejection by applying a drive voltage to each ejection head of a head unit in which a plurality of the ejection heads having an array of nozzles that eject droplets perpendicularly onto a printing surface which is inclined with respect to the horizontal plane, the plurality of ejection heads being arranged in an array direction of the nozzles,
nozzles to be driven of each ejection head in an overlap region between adjacent ejection heads being determined after correcting the drive voltages of adjacent ejection heads based on the density difference between adjacent ejection heads.
